(19) United States
(12) Patent Application Publication
(10) Pub. No.: US 2008/0179123 A1
(43) Pub. Date: Jul. 31, 2008

(54) AC/DC system for powering a vehicle

(76) Inventors: Andrew A. Steger, Lynchburg, VA (US); Fred A. Steger, McAllen, TX (US)

Correspondence Address: PETER J. VAN BERGEN, 402 WEST DUKE OF GLOUCESTER STREET, WILLIAMSBURG, VA, 23185, US

(21) Appl. No.: 11/700,506

(22) Filed: Jan. 31, 2007

(51) Int. Cl. B60K 1/02; H02P 5/60; B60L 11/16; B60L 11/18; B60K 25/08

(52) U.S. Cl. 180/165; 318/107; 180/65.4

(57) ABSTRACT

A system for powering a vehicle includes a DC motor adapted to be coupled to a vehicle axle when the vehicle is to be driven in reverse or forward at a speed less than a threshold, and an AC motor adapted to be coupled to vehicle axle when it is to be driven forward at a speed exceeding the threshold. An AC turbine adapted to be driven by motion of the vehicle generates an AC current for powering the AC motor when the AC turbine is coupled thereto. An operator-controlled rheostat is used to control the speed of either the AC or DC motor. A switching system uncouples the AC turbine from the AC motor and couples a battery to the DC motor through the rheostat when the vehicle is driven in reverse or forward at a speed less than the threshold. The switching system also serves to uncouple the battery from the DC motor and couple the AC turbine to the AC motor through the rheostat when the vehicle is driven forward at a speed exceeding the threshold.

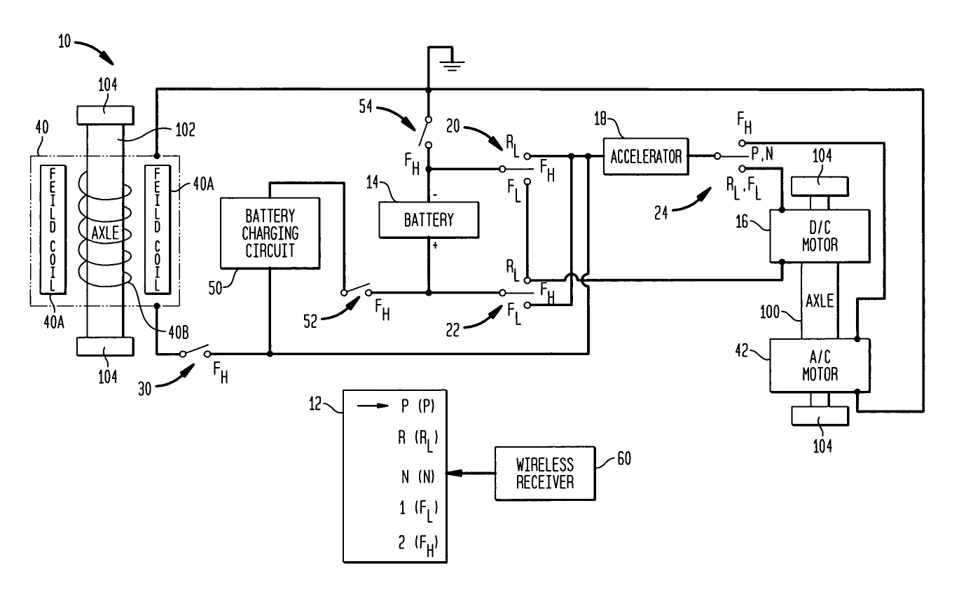

### FIELD OF THE INVENTION

The invention relates generally to electric powered vehicles, and more particularly to a vehicle powering system that uses both AC and DC electric power.

### BACKGROUND OF THE INVENTION

The problems associated with gasoline-powered vehicles are very well known. Environmental concerns, geo-political tensions, and economic crises can all be linked to the use of gasoline to power the world's vehicles. Accordingly, efforts are being made to design and develop vehicles that require either less gasoline (e.g., hybrid vehicles) or no gasoline (e.g., fuel cell vehicles, electric vehicles, etc.). While many of these vehicles show promise, none has emerged as a “clear choice” replacement for traditional gasoline-powered vehicles. The reasons for this are varied and include excessive cost, unproven technologies, vehicles that are underpowered for their intended purpose or the environment in which they will be used, lack of infrastructure to handle “re-fueling” of vehicles utilizing new technologies, etc.

### SUMMARY OF THE INVENTION

Accordingly, it is an object of the present invention to provide a system for powering a vehicle that does not use gasoline.

Another object of the present invention is to provide an electric power system for a vehicle utilizing well known and safe technologies.

Still another object of the present invention is to provide an electric power system for a vehicle that utilizes motion of the vehicle in the powering process.

Other objects and advantages of the present invention will become more obvious hereinafter in the specification and drawings.

In accordance with the present invention, a system for powering a vehicle includes a DC motor adapted to be coupled to a vehicle axle when the vehicle is to be driven in reverse or forward at a speed less than a threshold. A battery is provided to power the DC motor when coupled thereto. The system further includes an AC motor adapted to be coupled to a vehicle axle when it is to be driven forward at a speed exceeding the threshold, and an AC turbine adapted to be driven by motion of the vehicle. The AC turbine generates an AC current for powering the AC motor when the AC turbine is coupled thereto. An operator-controlled rheostat is used to control the speed of either the AC or DC motor. A provided switching system links the DC motor, battery, AC motor, AC turbine and rheostat. Specifically, the switching system uncouples the AC turbine from the AC motor and couples the battery to the DC motor through the rheostat when the vehicle is driven in reverse or forward at a speed less than the threshold. In this configuration, the vehicle is powered by the DC motor. The switching system also serves to uncouple the battery from the DC motor and couple the AC turbine to the AC motor through the rheostat when the vehicle is driven forward at a speed exceeding the threshold. In this configuration, the vehicle is powered by the AC motor.

### BRIEF DESCRIPTION OF THE DRAWINGS

Other objects, features and advantages of the present invention will become apparent upon reference to the following description of the preferred embodiments and to the drawings, wherein:

The sole FIGURE is a schematic view of an AC/DC electric power system for a vehicle in accordance with the present invention.

### DETAILED DESCRIPTION OF THE INVENTION

Referring now to the drawings and more particularly to the sole FIGURE, a system for powering a vehicle using DC and AC electrical power is shown and is referenced generally by numeral 10. While system 10 could be adapted for use in a variety of types of vehicles, it is well-suited for land-based vehicles such as passenger automobiles. Accordingly, the present invention will be explained for its use in vehicles that have axles coupled to the vehicle's wheels. By way of example, the present invention is illustrated using two axles 100 and 102 and four wheels 104. However, it is to be understood that the present invention could be used with vehicles having more axles/wheels without departing from the scope of the present invention. For clarity of illustration, operative features of the present invention are divided between the two axles as will be explained further below. However, it is further to be understood that these features could be coupled to a single axle without departing from the scope of the present invention.

In general, system 10 uses either DC power or AC power to bring about mechanical motion (e.g., rotation) of axle 100. More specifically, at slow vehicle speeds, DC power is used while AC power is used for faster vehicle speeds. The transition between slow and fast vehicle speeds is governed in the illustrated example by a user-controlled switcher 12 (maintained on the vehicle) having a number of user-selected settings such as park (“P”), reverse (“R”), neutral (“N”), forward at slow speeds (“1”), and forward at faster speeds (“2”). Additional or alternate settings could also be employed without departing from the scope of the present invention. Switcher 12 is used to configure system 10 for one of AC or DC power for the vehicle operating in one of a reverse mode, a forward mode at a slow speed, and a forward mode at a higher speed. Accordingly, switcher 12 can be made to appear like a standard vehicle gearshift in the passenger compartment of the vehicle.

Since a vehicle typically starts from a stopped position when accelerating in reverse or just starting to move forward, both the reverse mode and forward mode at a slow speed are well-suited to utilize DC power. Specifically, system 10 includes a battery 14 and a DC motor 16 to supply DC powered energy directly to axle 100. For example, DC motor 16 can include a slip clutch (not shown) for direct coupling of the motor's rotational components to axle 100. In this example, the motor's slip clutch would be configured to engage axle 100 when DC motor 16 receives power and disengage from axle 100 when DC motor 16 does not receive power.

Control of the DC power to thereby control the speed of the vehicle is achieved by routing the DC power from battery 14 to DC motor 16 through the vehicle's accelerator 18 which is essentially a user-controlled rheostat. The DC power is routed from battery 14 through accelerator 18 to DC motor 16 via a series of switches 20, 22 and 24 that are coupled to switcher 12. That is, the position of each of switches 20, 22 and 24 is set based on the setting of switcher 12. For example, when the vehicle's switcher 12 is placed in the park (“P”) or neutral (“N”) settings, switch 24 is opened so that accelerator 18 is uncoupled from both DC motor 16 and AC motor 42 (which is similarly “slip clutch” coupled to axle 100). In the reverse setting, switches 20, 22 and 24 are set to the “R_{L}” position and battery 14 is coupled to DC motor 16 through accelerator 18 such that DC motor 16 causes axle 100 to rotate such that reverse motion is imparted to the vehicle. When switcher 12 is placed in the forward setting at a slow speed, switches 20, 22 and 24 are set to the “F_{L}” position and the current polarity is changed (relative to the reverse setting) a such that axle 100 now imparts forward motion to the vehicle. In either case, the speed of the vehicle is adjusted by the user via accelerator 18.

At a desired threshold speed, system 10 is switched over to AC power. The threshold speed essentially defines the highest speed for DC power and the lowest speed for AC power. The particular threshold speed is a design choice that is not a limitation of the present invention. Switching to AC power can be accomplished manually (e.g., by the user changing the setting of switcher 12) or it could be governed by an automatic switching controller (not shown). For safety reasons, it may be desirable to prevent the vehicle from being driven too fast in reverse. For this reason, switching from DC power to AC power could be limited to forward settings of switcher 12 as is the case with the illustrated example of the present invention.

When switcher 12 is switched to the forward setting at a higher speed or “2”, switches 20 and 22 are set to the “F_{H}” position which uncouples battery 14 from DC motor 16. As a result of losing power, DC motor 16 is uncoupled from axle 100 so that axle 100 is no longer powered thereby. At the same time, switches 24 and 30 are set so that an AC turbine 40 is coupled to an AC motor 42 which, in turn, is coupled to axle 100. That is, similar to DC motor 16, AC motor 42 is “slip clutch” coupled to axle 100 so that its rotational components directly engage axle 100 when receiving electrical power. The AC power generated by AC turbine 40 is supplied to AC motor 42/axle 100 in a user-controlled amount by (rheostat) accelerator 18.

AC turbine 40 is designed to have its electricity-generating mechanism (i.e., rotor) turned as a direct result of vehicle motion. In the illustrated example, AC turbine 40 includes a stationary field coil 40A disposed about an armature coil 40B that is wound about axle 102. Accordingly, as axle 102 rotates during any vehicle motion, AC turbine 40 generates AC power. The AC power is used to power the vehicle once the vehicle has attained its desired threshold speed. As described above, battery 14 supplies the power for low-speed vehicle operation via DC motor 16. Typically, battery 14 will be some sort of rechargeable cell (s). The recharging of battery 14 can occur during vehicle down time (e.g., at night) by coupling battery 14 to a conventional battery charger (not shown). Additionally or alternatively, system 10 can be equipped with an onboard battery charging capability. That is, system 10 can be equipped to recharge battery 14 during operation of the vehicle at higher speeds when AC turbine 40 is operating. In such a case, a battery charging circuit 50 can be provided and coupled to battery 14 for the charging thereof. The coupling of battery charging circuit 50 into and out of system 10 is governed by switches 52 and 54. Similar to the other switches in system 10, the positions of switches 52 and 54 are set by switcher 12. Battery charging circuit 50 would typically include voltage rectification and other signal conditioning circuitry as would be well understood in the art.

The advantages of the present invention are numerous. The self-sustaining, all-electric vehicle power system does not require any gasoline or other fossil fuel. The system should be suitable for many basic passenger vehicle applications, especially highway driving where vehicle motion remains fairly constant for relatively long periods. Environmentally, the system will reduce both air and noise pollution. Complex gear and drive train mechanisms are virtually eliminated as the axle(s) are directly driven by the rotating components of either the DC or AC motors.

Although the invention has been described relative to a specific embodiment thereof, there are numerous variations and modifications that will be readily apparent to those skilled in the art in light of the above teachings. For example, if high levels of electric current will pass through the system, the system's “switches” could include high-current-handling relays to handle the actual current flow. The system can be adapted to a variety of motor and turbine configurations without departing from the scope of the present invention. The various elements of the system can be positioned for optimum efficiency depending on the vehicle type, application, and the environment in which it will be used. For example, each of the DC and AC motors and AC turbine could be coupled to a separate axle. The AC turbine could be mechanically or electronically “subtracted” from the system when the vehicle is operating on DC power to minimize drag on the system operating at low speeds. The particular “low speed-to-high speed threshold” could be changed to suit user preferences, driving applications, environments, or habits. The setting of this threshold could be factory set, user-controlled, government-controlled, or even automatically adjusted. For example, the present invention could include a wireless receiver 60 coupled to switcher 12. In this way, a wireless signal could be used to adjust the threshold speed when a vehicle entered a particular geographic region or a region defined by a specific kind of driving (e.g., flat terrain, hilly terrain, highway driving. etc.). It is therefore to be understood that, within the scope of the appended claims, the invention may be practiced other than as specifically described.

What is claimed as new and desired to be secured by Letters Patent of the United States is:

1. A system for powering a vehicle, comprising:
a DC motor adapted to be coupled to an axle of a vehicle when the vehicle is to be driven in reverse or forward at a speed less than a threshold;
a battery for powering said DC motor when coupled thereto;
an AC motor adapted to be coupled to an axle of the vehicle when the vehicle is to be driven forward at a speed exceeding said threshold;
an AC turbine adapted to be driven by motion of the vehicle wherein an AC current is generated thereby for powering said AC motor when said AC turbine is coupled thereto;
an operator-controlled rheostat; and
switching means coupled to said DC motor, said battery, said AC motor, said AC turbine and said rheostat, for uncoupling said AC turbine from said AC motor and coupling said battery to said DC motor through said rheostat when the vehicle is driven in reverse or forward at a speed less than said threshold wherein the vehicle is powered by said DC motor, and for uncoupling said battery from said DC motor and coupling said AC turbine to said AC motor through said rheostat when the vehicle is driven forward at a speed exceeding said threshold wherein the vehicle is powered by said AC motor.

2. A system as in claim 1 further comprising a battery charging circuit electrically coupled between said AC turbine and said battery by said switching means when the vehicle is driven forward at a speed exceeding said threshold.

3. A system as in claim 1 wherein said AC turbine is adapted to include an axle of the vehicle.

4. A system as in claim 1 wherein said AC turbine comprises:
an armature coil adapted to be wound about an axle of the vehicle for rotation therewith; and
a field coil disposed about said armature coil wherein said armature coil rotates within said field coil when the axle so-wound rotates.

5. A system as in claim 1 wherein said switching means includes an operator-controlled switch positionable to one of a plurality of settings to include a reverse setting when the vehicle is to be driven in reverse at a speed less than said threshold, a first forward setting when the vehicle is to be driven forward at a speed less than said threshold, and a second forward setting when the vehicle is to be driven forward at a speed that exceeds said threshold.

6. A system as in claim 1 further comprising a wireless receiver coupled to said switching means for receiving a value for said threshold in a wireless fashion.

7. A system for powering a vehicle, comprising:
a user-operated control switchable between a plurality of settings to include a reverse setting for reverse vehicle speeds up to a threshold speed, a first forward setting for forward vehicle speeds up to said threshold speed, and a second forward setting for forward vehicle speeds that exceed said threshold speed;
a DC motor adapted to be coupled to an axle of a vehicle when said control is in one of the reverse setting and the first forward setting;
a battery for powering said DC motor when coupled thereto;
an AC motor adapted to be coupled to the axle of the vehicle when said control is in the second forward setting;
an AC turbine adapted to be driven by motion of the vehicle wherein an AC current is generated thereby for powering said AC motor when said AC turbine is coupled thereto;
an operator-controlled rheostat; and
switching means coupled to said DC motor, said battery, said AC motor, said AC turbine and said rheostat, said switching means further coupled to said control for uncoupling said AC turbine from said AC motor and coupling said battery to said DC motor through said rheostat when said control is in one of the reverse setting and first forward setting, and for uncoupling said battery from said DC motor and coupling said AC turbine to said AC motor through said rheostat when said control is in the second forward setting.

8. A system as in claim 7 further comprising a battery charging circuit electrically coupled between said AC turbine and said battery by said switching means when the gearshift is in the second forward setting.

9. A system as in claim 7 wherein said AC turbine is adapted to include an axle of the vehicle.

10. A system as in claim 7 wherein said AC turbine comprises:
an armature coil adapted to be wound about an axle of the vehicle for rotation therewith; and
a field coil disposed about said armature coil wherein said armature coil rotates within said field coil when the axle so-wound rotates.

11. A system as in claim 7 further comprising a wireless receiver coupled to said control for receiving a value for said threshold speed in a wireless fashion.

12. A system for powering a vehicle, comprising:
a user-operated control switchable between a plurality of settings to include a reverse setting for reverse vehicle speeds up to a threshold speed, a first forward setting for forward vehicle speeds up to said threshold speed, and a second forward setting for forward vehicle speeds that exceed said threshold speed;
a wireless receiver coupled to said control for receiving a value for said threshold speed in a wireless fashion;
a DC motor adapted to be coupled to an axle of a vehicle when said control is in one of the reverse setting and the first forward setting;
a battery for powering said DC motor when coupled thereto;
an AC motor adapted to be coupled to the axle of the vehicle when said control is in the second forward setting;
an AC turbine adapted to be driven by motion of the vehicle wherein an AC current is generated thereby for powering said AC motor when said AC turbine is coupled thereto, said AC turbine including (i) an armature coil adapted to be wound about an axle of the vehicle for rotation therewith, and (ii) a field coil disposed about said armature coil;
an operator-controlled rheostat; and
switching means coupled to said DC motor, said battery, said AC motor, said AC turbine and said rheostat, said switching means further coupled to said control for uncoupling said AC turbine from said AC motor and coupling said battery to said DC motor through said rheostat when said control is in one of the reverse setting and first forward setting, and for uncoupling said battery from said DC motor and coupling said AC turbine to said AC motor through said rheostat when said control is in the second forward setting.
